(19) United States
(12) Patent Application Publication
(10) Pub. No.: US 2009/0294558 A1
(43) Pub. Date: Dec. 3, 2009

(54) APPARATUS FOR CRUSHING GRAINS AND METHOD THEREOF

(76) Inventor: John Bihn, Ft. Recovery, OH (US)

Correspondence Address: JAY M. SCHLOFF, 6960 Orchard Lake Road, Suite 315, West Bloomfield, MI, 48322, US

(21) Appl. No.: 12/472,531

(22) Filed: May 27, 2009

Related U.S. Application Data
(60) Provisional application No. 61/057,077, filed on May 29, 2008.

(51) Int. Cl. B02C 4/06; B02C 4/08

(52) U.S. Cl. 241/6; 241/236

(57) ABSTRACT

Disclosed is an apparatus for crushing grains, and a method thereof. The apparatus includes a driving mechanism, a plurality of shafts and a plurality of rollers. The driving mechanism is coupled to and configured to rotate at least one shaft of the plurality of shafts. Each roller of the plurality of rollers is axially coupled to a shaft of the plurality of shafts. A protruding member of a plurality of protruding members extends from a first roller of the plurality of rollers and intermeshes with two adjacent protruding members of a plurality of protruding members that extend from a second roller of the plurality of rollers to form an intermeshing mechanism. The first roller and the second roller are separated by a predefined clearance distance. The intermeshing mechanism crushes the grains based on the rotation of the first roller and the second roller.

### CROSS-REFERENCE TO RELATED APPLICATIONS

This application is claims priority under 35 U.S.C. §119 upon the U.S. provisional patent application Ser. No. 61/057,077, filed May 28, 2009, the disclosure of which is incorporated by reference.

### FIELD OF THE DISCLOSURE

The present disclosure relates generally to agriculture-related apparatuses, and, more particularly, to an apparatus for crushing grains.

### BACKGROUND OF THE DISCLOSURE

Generally, grains are processed after harvesting to convert the grains into a form that may be consumed by humans, livestock, and the like. Various processes that may be carried out on harvested grains include crimping, wilting, chopping, grinding, crushing and the like. A process, such as crushing, involves breaking the grains into smaller particles that are easily consumable by humans, livestock, and the like.

Various techniques exist for crushing the grains into smaller particles. One such technique utilizes a pair of rollers in which a roller (hereinafter referred to as ‘drive roller’) of the pair of rollers is placed beside another roller (hereinafter referred to as ‘driven roller’) of the pair of rollers. The pair of rollers is operably coupled to each other via a shaft. The drive roller and the driven roller are co-axial with respect to the shaft. The shaft is configured on an axis that passes through center portions of the pair of rollers. The drive roller is composed of a cavity that is disposed around the shaft. The cavity is configured to receive the grains for crushing. The driven roller is fixed at a position while the drive roller is capable of being rotated about the axis. A lever configured on the drive roller assists a user in rotating the drive roller about the axis, with the driven roller fixed at the position. As the drive roller is rotated along the axis, the grain in the cavity is crushed into smaller pieces due to a force of friction between the pair of rollers.

However, crushing the grains by using the technique explained above is associated with a few drawbacks. The force of friction that exists between the top roller and the bottom roller increases wear and tear of the pair of rollers. The wear and tear of the pair of rollers creates metal dust that may mix with the particles obtained from crushing the grains, making the particles unsuitable for consumption. Further, the particles obtained from crushing the grains may be of varying sizes, and, such particles of varying sizes may not be suitable for consumption by humans, livestock, and the like. Particularly, the grains may be crushed to very fine particles such as grain dust that may be unsuitable for consumption. Further, sometimes, this technique may need to be repeated more than once to get a required size of the particles. Thus, this technique may require a lot of time and manual power to crush the grains into the smaller particles.

Based on the above mentioned drawbacks, there is a need for crushing grains into substantially uniform-sized particles. Further, there is a need for reducing wear and tear of an apparatus that crushes grains. Furthermore, there is a need for reducing metal dust present in particles obtained from crushing grains. Furthermore, there is need for reducing grain dust. Moreover, there is need for reducing manual power and time required for crushing grains.

### SUMMARY

In view of the foregoing disadvantages inherent in the prior art, the general purpose of the present disclosure is to provide an apparatus for crushing grains, and method thereof, configured to include all the advantages of the prior art, and to overcome the drawbacks inherent therein.

Accordingly, an object of the present disclosure is to crush grains.

Another object of the present disclosure is to reduce wear and tear of an apparatus that crushes grains.

Yet another object of the present disclosure is to reduce formation of metal dust by an apparatus that crushes grains.

Still another object of the present disclosure is to reduce formation of grain dust.

Yet another object of the present disclosure is to reduce time required for crushing grains.

Still another object of the present disclosure is to reduce manpower required for crushing grains.

In light of the above objects, in one aspect of the present disclosure, an apparatus for crushing grains is provided. The apparatus includes a plurality of shafts, a driving mechanism and a plurality of rollers. Each shaft of the plurality of shafts is configured to rotate about a corresponding axis of rotation. The driving mechanism is operably coupled to at least one shaft of the plurality of shafts. The driving mechanism is configured to rotate the at least one shaft. Each roller of the plurality of rollers is axially coupled to a corresponding shaft of the plurality of shafts. The each roller is configured to rotate about an axis of rotation of the corresponding shaft. The each roller of the plurality of rollers includes a plurality of protruding members extending from a curved surface of the each roller. A protruding member of the plurality of protruding members, extending from a first roller of the plurality of rollers, intermeshes with two adjacent protruding members of the plurality of protruding members extending from a second roller of the plurality of rollers to form an intermeshing mechanism. The first roller and the second roller are separated by a predefined clearance distance. The intermeshing mechanism is configured to receive the grains. The intermeshing mechanism exerts a crushing force on the grains based on rotation of the first roller and the second roller, thereby crushing the grains.

In another aspect of the present disclosure, a method for crushing grains by an apparatus is provided. The method includes receiving the grains into an intermeshing mechanism of the apparatus. The intermeshing mechanism is formed by a protruding member of a plurality of protruding members extending from a curved surface of a first roller of a plurality of rollers of the apparatus and two adjacent protruding members of a plurality of protruding members extending from a curved surface of a second roller of the plurality of rollers. The method further includes rotating the first roller and the second roller by a driving mechanism for enabling the intermeshing mechanism to exert a crushing force on the grains. The first roller and the second roller are separated by a predefined clearance distance. Further, the crushing force exerted on the grains by the intermeshing mechanism based on the rotation of the first roller and the second roller, crushes the grains.

These together with other aspects of the present disclosure, along with the various features of novelty that characterize the present disclosure, are pointed out with particularity in the claims annexed hereto and form a part of this present disclosure. For a better understanding of the present disclosure, its operating advantages, and the specific objects attained by its uses, reference should be made to the accompanying drawing and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, in which:

FIG. 1 illustrates a perspective view of an apparatus for crushing grains, in accordance with an embodiment of the present disclosure.

FIG. 2 illustrates a side view of a pair of rollers of the apparatus of FIG. 1, in accordance with an embodiment of the present disclosure.

FIG. 3 illustrates a flow chart of a method for crushing grains by an apparatus, in accordance with an embodiment of the present disclosure.

Like reference numerals refer to like parts throughout the description of several views of the drawings.

### DETAILED DESCRIPTION OF THE DISCLOSURE

The exemplary embodiments described herein detail for illustrative purposes are subject to many variations in composition, structure, and design. It should be emphasized, however, that the present disclosure is not limited to a particular apparatus for crushing grains, and method thereof, as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present disclosure provides an apparatus for crushing grains, and a method thereof. Examples of the grains include barley, buckwheat, corn, flint corn, wheat, and the like. The apparatus includes a plurality of shafts, a driving mechanism and a plurality of rollers. Each shaft of the plurality of shafts is configured to rotate about a corresponding axis of rotation. The driving mechanism is operably coupled to at least one shaft of the plurality of shafts. The driving mechanism is configured to rotate the at least one shaft. Each roller of the plurality of rollers is axially coupled to a corresponding shaft of the plurality of shafts. The each roller is configured to rotate about an axis of rotation of the corresponding shaft. The each roller of the plurality of rollers includes a plurality of protruding members extending from a curved surface of the each roller. A protruding member of the plurality of protruding members, extending from a curved surface of a first roller of the plurality of rollers, intermeshes with two adjacent protruding members of the plurality of protruding members extending from a curved surface of a second roller of the plurality of rollers to form an intermeshing mechanism. The first roller and the second roller are separated by a predefined clearance distance. The intermeshing mechanism is configured to receive the grains. The intermeshing mechanism exerts a crushing force on the grains based on rotation of the first roller and the second roller, thereby crushing the grains.

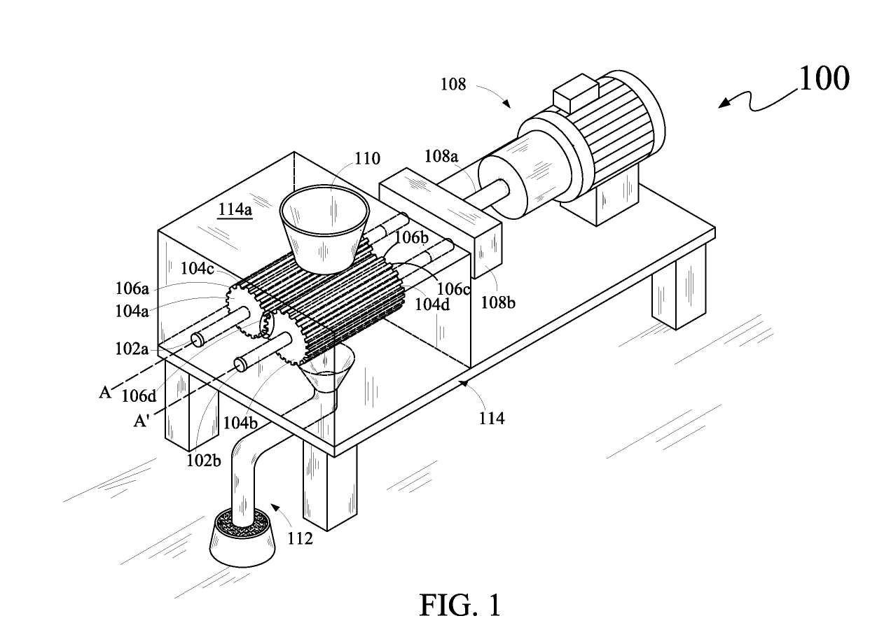

FIG. 1 illustrates a perspective view of an apparatus 100 for crushing grains, in accordance with an embodiment of the present disclosure. Specifically, the apparatus 100 is configured to crush the grains into substantially uniform-sized particles. Examples of the grains may include barley, buckwheat, corn, flint corn, and the like. The apparatus 100 includes a plurality of shafts, such as a shaft 102a and a shaft 102b (hereinafter collectively referred to as ‘plurality of shafts 102’), a plurality of rollers, such as a roller 104a and a roller 104b (hereinafter collectively referred to as ‘plurality of rollers 104’), a plurality of protruding members, such as a protruding member 106a, a protruding member 106b and a protruding member 106c, a driving mechanism 108 (also referred to as ‘motor assembly 108’), a driver shaft 108a (also referred to as ‘motor shaft 108a’), a coupling unit 108b, a hopper 110, a grain collector assembly 112 and a support structure 114.

Each shaft of the plurality of shafts 102 is capable of rotating about a corresponding axis of rotation, such as an axis A and an axis A′. The driving mechanism 108 is operably coupled to at least one shaft of the plurality of shafts 102. The driving mechanism 108 is configured to rotate the at least one shaft. Each roller of the plurality of rollers 104 is axially coupled to a corresponding shaft of the plurality of shafts 102. The each roller is configured to rotate about an axis of rotation of the corresponding shaft. Specifically, the roller 104a is configured to rotate about the axis A, and the roller 104b is configured to rotate about the axis A′. Further, the each roller of the plurality of rollers 104 includes a plurality of protruding members extending from a curved surface of the each roller. Specifically, the roller 104a includes the plurality of protruding members, such as the protruding member 106a, extending from a curved surface 104c of the roller 104a. Similarly, the roller 104b includes the plurality of protruding members, such as the protruding member 106b and the protruding member 106c, extending from a curved surface 104d of the roller 104b.

The protruding member 106a of a first roller, such as the roller 104a (hereinafter referred to as ‘first roller 104a’) of the plurality of rollers 104 forms an intermeshing mechanism 106d with two adjacent protruding members, such as the protruding member 106b and the protruding member 106c of a second roller, such as the roller 104b (hereinafter referred to as ‘second roller 104b’) of the plurality of rollers 104. The first roller 104a and the second roller 104b are separated by a predefined clearance distance. The intermeshing mechanism 106d is configured to receive the grains. The intermeshing mechanism 106d exerts a crushing force on the grains based on the rotation of the first roller 104a and the second roller 104b, thereby crushing the grains into the substantially uniform-sized particles.

Referring to FIG. 1, the support structure 114 is coupled to the driving mechanism 108. More specifically, the support structure 114 is configured to provide mechanical support to the driving mechanism 108. Further, the support structure 114 is configured to provide mechanical support to other components of the apparatus 100, as depicted.

The shaft 102a of the apparatus 100 is configured to rotate about the axis A and the shaft 102b is configured to rotate about the axis A′. In an embodiment of the present disclosure, the axis of rotation of the shaft 102a, i.e. axis A, and the axis of rotation of the shaft 102b, i.e., axis A′ are parallel to each other, as depicted in FIG. 1. The plurality of rollers 104 is coupled to the plurality of shafts 102. More specifically, the first roller 104a is axially coupled to the shaft 102a and the second roller 104b is axially coupled to the shaft 102b. The first roller 104a is configured to rotate about the axis of rotation of the shaft 102a, i.e. axis A. Similarly, the second roller 104b is configured to rotate about the axis of rotation of the shaft 102b, i.e. axis A′.

The plurality of protruding members of the first roller 104a may be configured to rotate based on the rotation of the first roller 104a about the axis A. Similarly, the plurality of protruding members of the second roller 104b may be configured to rotate based on the rotation of the second roller 104b about the axis A′. In an embodiment of the present disclosure, the plurality of protruding members of the first roller 104a may be composed of one of a plurality of teeth, a plurality of pins and a plurality of lobes. Further, the plurality of protruding members of the second roller 104b may be complementary to the plurality of protruding members of the first roller 104a.

The plurality of protruding members of the first roller 104a and the plurality of protruding members of the second roller 104b are coupled together to form the intermeshing mechanism 106d therebetween. It will be apparent to a person skilled in the art that the intermeshing mechanism 106d extends along a length of the first roller 104a and the second roller 104b.

The first roller 104a and the second roller 104b are separated by the predefined clearance distance. Accordingly, the axis A of the first roller 104a and the axis A′ of the second roller 104b may be separated by a predefined axial distance, based on radii of the first roller 104a and the second roller 104b. The axial distance may be defined as a distance between two axes of rotation, such as the axis A and the axis A′. In an embodiment of the present disclosure, the axial distance between the axis A and the axis A′ may be 5.156 inches. In an embodiment, the radii of the first roller 104a and the second roller 104b may be 2.578 inches.

The plurality of shafts 102 is operably coupled to the coupling unit 108b. The coupling unit 108b may include a gear system (not shown) for rotating the plurality of shafts 102 about their respective axes of rotation. The coupling unit 108b may be used to control speed of rotation of at least one shaft of the plurality of shafts 102, through the gear system. Further, the coupling unit 108b may be configured to provide a rotational coupling between the motor shaft 108a and the at least one shaft. The motor shaft 108a may be configured to rotate the at least one shaft based on power supplied by the motor assembly 108. In an embodiment of the present disclosure, the at least one shaft, that is rotationally coupled to the motor shaft 108a and operably coupled to the motor assembly 108, may be axially coupled to one of the first roller 104a and the second roller 104b. In another embodiment of the present disclosure, the motor assembly 108 may be operably coupled to each of the plurality of shafts 102. Further, the motor shaft 108a may be configured to rotate each of the plurality of shafts 102.

In another embodiment of the present disclosure, the apparatus 100 may include a manual rotation assembly (not shown) as the driving mechanism 108. The manual rotation assembly may be coupled to the at least one shaft of the plurality of shafts 102. The manual rotation assembly may be configured to rotate the at least one shaft. The manual rotation assembly may include a handle for rotating the at least one shaft. Further, the at least one shaft to be rotated by the manual rotation assembly may be operably coupled to one of the first roller 104a and the second roller 104b. It will be apparent to a person skilled in the art that the manual rotation assembly will include an assembly shaft (not shown) that is similar to the motor shaft 108a, and a coupling unit (not shown) that is similar to the coupling unit 108b for enabling rotation of the at least one shaft by the manual rotation assembly.

In an embodiment of the present disclosure, the shaft 102a may be configured to rotate due to rotation of the motor shaft 108a. The shaft 102a may, in turn, cause rotation of the first roller 104a. Accordingly, the rotation of the first roller 104a may cause the second roller 104b to rotate, based on the intermeshing mechanism 106d. In another embodiment of the present disclosure, each shaft of the plurality of shafts 102 may be configured to rotate based on the rotation of the motor shaft 108a. The first roller 104a and the second roller 104b rotate in opposite directions, as shown in FIG. 1, causing the intermeshing mechanism 106d to crush the grains into the substantially uniform-sized particles.

Specifically, the intermeshing mechanism 106d exerts a crushing force on the grains based on the rotation of the first roller 104a and the second roller 104b, thereby crushing the grains into the substantially uniform-sized particles. In an embodiment of the present disclosure, a range of sizes of the substantially uniform-sized particles is determined based on the predefined clearance distance. In one embodiment, the predefined clearance distance may be 0.02 inches. In another embodiment, the predefined clearance distance may be 0.07 inches. It will be apparent to one skilled in the art that the clearance distances recited herein are exemplary and not limiting. In an embodiment, the substantially uniform-sized particles may be 1000 microns in size. In another embodiment, the substantially uniform-sized particles may be 700 microns in size. It will be apparent to one skilled in the art that the particle sizes recited herein are exemplary and not limiting.

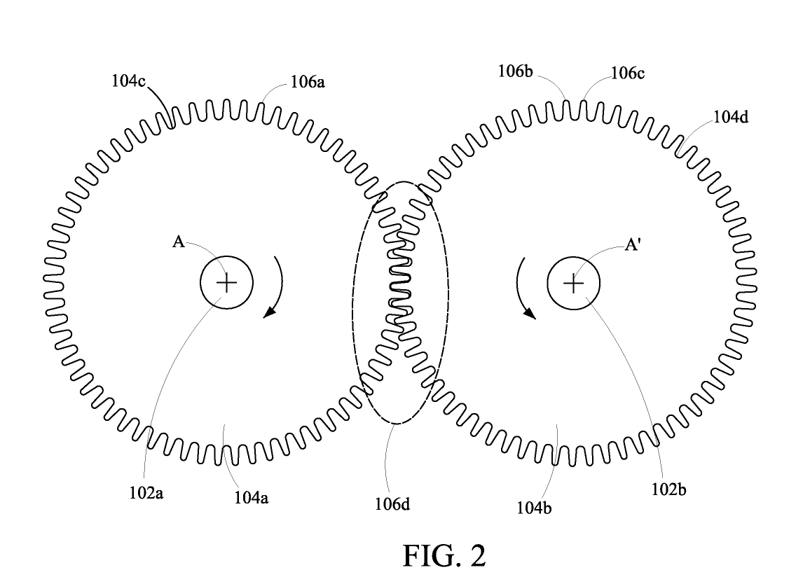

In an embodiment of the present disclosure, the apparatus 100 may include a hopper 110, as shown in FIG. 1, for receiving the grains to be crushed by the intermeshing mechanism 106d. The hopper 110 is coupled to the support structure 114 for feeding the grains into the intermeshing mechanism 106d. Furthermore, the apparatus 100 includes a grain collector assembly 112 coupled to the support structure 114. The grain collector assembly 112 is configured to receive the substantially uniform-sized particles crushed by the intermeshing mechanism 106d. The hopper 110 and the grain collector assembly 112 may be connected on outer surfaces of the support structure 114, as shown in FIG. 1. The hopper 110 is shown to be coupled to an outer surface 114a of the support structure 114. The grain collector assembly 112 is shown to be coupled to an outer surface (of the support structure 114) that is opposite to the outer surface 114a. It may be apparent to a person skilled in the art that the hopper 110 and the grain collector assembly 112 may assume various shapes other than those depicted in FIG. 1. Further, it may be apparent to a person skilled in the art that the hopper 110 and the grain collector assembly 112 may be positioned differently without affecting the scope of the present disclosure. Further, it will be apparent to a person skilled in the art that the apparatus 100 for crushing the grains (as depicted in FIG. 1) may include greater number of rollers and shafts, to form a greater number of intermeshing mechanisms for crushing the grains into the substantially uniform-sized particles. The intermeshing mechanism 106d of the apparatus 100 is explained in more detail in FIG. 2.

FIG. 2 illustrates a side view of the first roller 104a and the second roller 104b of the apparatus 100 of FIG. 1, in accordance with an embodiment of the present disclosure. The first roller 104a includes the plurality of protruding members, such as the protruding member 106a and the second roller 104b includes the plurality of protruding members, such as the protruding member 106b and the protruding member 106c. The plurality of protruding members of the first roller 104a and the plurality of protruding members of the second roller 104b couple together to form the intermeshing mechanism 106d therebetween.

The plurality of protruding members of the first roller 104a may be composed of one of a plurality of teeth, a plurality of pins and a plurality of lobes. The plurality of protruding members of the second roller 104b are complementary to the plurality of protruding members of the first roller 104a, as depicted in FIG. 1.

Further, a height and a pitch associated with the plurality of protruding members of the first roller 104a and the plurality of protruding members of the second roller 104b may vary based on type, length, and moisture content of the grains to be crushed. In an embodiment, the height of the protruding members may be 0.125 inches, with a corresponding pitch of 0.020 inches. In another embodiment, the height of the protruding members may be 1.00 inches, with a corresponding pitch of 0.110 inches It will be apparent to one skilled in the art that the dimensions recited herein are exemplary and not limiting.

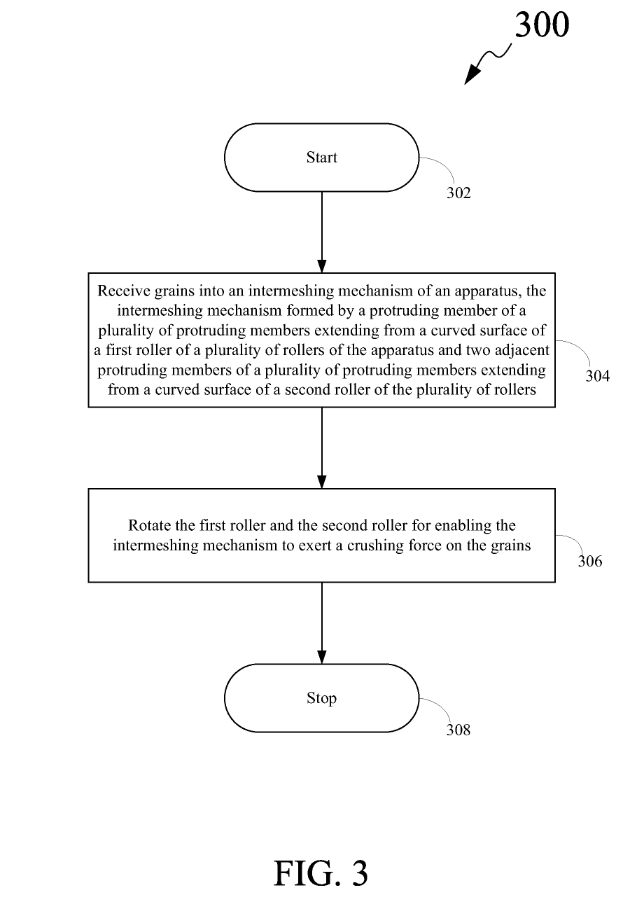

The grains to be crushed by the apparatus 100 may be received by the intermeshing mechanism 106d via the hopper 110, as explained in FIG. 1. As the grains pass through the intermeshing mechanism 106d, the first roller 104a and the second roller 104b are rotated along the axis A and the axis A′ respectively. The rotation of the first roller 104a and the second roller 104b causes intermeshing of the plurality of protruding members of the first roller 104a and the plurality of protruding members of the second roller 104b, respectively, as explained in conjunction with FIG. 1. The intermeshing exerts a combination of compressive forces and shear forces on the grains passing through the intermeshing mechanism 106d, thereby causing the grains to be crushed into the substantially uniform-sized particles. A method for crushing the grains into the substantially uniform-sized particles is explained in conjunction with FIG. 3.

FIG. 3 illustrates a flow chart of a method for crushing grains by an apparatus, such as the apparatus 100, in accordance with an embodiment of the present disclosure. Specifically, the grains are crushed by the apparatus into substantially uniform-sized particles. Examples of the grains include, but are not limited to, barley, buckwheat, corn and flint corn.

The method 300 initiates at 302. At 304, the grains are received into an intermeshing mechanism, such as the intermeshing mechanism 106d. The intermeshing mechanism 106d is formed by a protruding member, such as the protruding member 106a, of a plurality of protruding members extending from a curved surface of a first roller, such as the first roller 104a, and two adjacent protruding members, such as the protruding members 106b and the protruding member 106c extending from a curved surface of a second roller, such as the second roller 104b. In an embodiment of the present disclosure, the plurality of protruding members of the first roller may be composed of one of a plurality of teeth, a plurality of pins and a plurality of lobes. Accordingly, the plurality of protruding members of the second roller may be composed of one of the plurality of teeth, the plurality of pins and the plurality of lobes to complement the plurality of protruding members of the first roller.

In an embodiment of the present disclosure, the grains may be received in a hopper, such as the hopper 110 of the apparatus 100. The hopper may be coupled to a support structure, such as the support structure 114 of the apparatus 100 to feed the grains into the intermeshing mechanism 106d. The hopper may include a wide opening through which the grains may be received into the hopper. It may be apparent to a person skilled in the art that shape, size and position of the hopper may vary depending on type and length of the grains, and crushing capacity of the apparatus.

At 306, the first roller and the second roller are rotated by a driving mechanism, such as the driving mechanism 108 explained in conjunction with FIG. 1, for enabling the intermeshing mechanism to exert a crushing force on the grains. The first roller and the second roller are separated by a predefined clearance distance. The crushing force exerted on the grains by the intermeshing mechanism is based on rotation of the first roller and the second roller. The intermeshing mechanism and the rotation of the first roller and the second roller exert a compressive force and a shear force on the grains. Accordingly, the compressive force and the shear force cause the grains to be crushed into the substantially uniform-sized particles. The substantially uniform-sized particles may be collected in a grain collector assembly, such as the grain collector assembly 112 that is coupled to the support structure 114 of the apparatus. At 308, the method 300 ends.

It will be apparent to a person skilled in the art that method 300 as described above may be performed on a variety of apparatuses that may be structurally different from the apparatus 100. However, intermeshing mechanisms of the variety of apparatuses may have the predefined clearance distance as specified herein, in order to crush the grains into the substantially uniform-sized particles.

The present disclosure provides an apparatus, such as the apparatus 100, for crushing grains into substantially uniform-sized particles, and a method, such as the method 300 thereof. The apparatus has reduced wear and tear, due to a predefined clearance distance in an intermeshing mechanism of the apparatus. Accordingly, the reduced wear and tear causes reduction in metal dust in the substantially uniform-sized particles crushed by the apparatus. Further, the clearance distance in the intermeshing mechanism crushes the grains into substantially uniform-sized particles, thereby reducing formation of grain dust. Furthermore, the intermeshing mechanism reduces repetition of the method, thereby crushing the grains in an efficient manner. Further, the reduction in repetition also saves time and manual effort.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

What is claimed is:

1. An apparatus for crushing grains, the apparatus comprising:
a plurality of shafts, each shaft of the plurality of shafts capable of rotating about a corresponding axis of rotation;
a driving mechanism operably coupled to at least one shaft of the plurality of shafts, the driving mechanism configured to rotate the at least one shaft; and
a plurality of rollers, each roller of the plurality of rollers axially coupled to a corresponding shaft of the plurality of shafts, the each roller configured to rotate about an axis of rotation of the corresponding shaft, the each roller of the plurality of rollers comprising a plurality of protruding members extending from a curved surface of the each roller,
wherein a protruding member of the plurality of protruding members extending from a curved surface of a first roller of the plurality of rollers intermeshes with two adjacent protruding members of the plurality of protruding members extending from a curved surface of a second roller of the plurality of rollers to form an intermeshing mechanism, the first roller and the second roller separated by a predefined clearance distance, and,
wherein the intermeshing mechanism is configured to receive the grains, and,
wherein the intermeshing mechanism exerts a crushing force on the grains based on rotation of the first roller and the second roller, thereby crushing the grains.

2. The apparatus of claim 1, wherein the driving mechanism is a motor assembly.

3. The apparatus of claim 1, wherein the at least one shaft is axially coupled to one of the first roller and the second roller.

4. The apparatus of claim 1, wherein the plurality of protruding members of the each roller is composed of one of a plurality of teeth, a plurality of pins and a plurality of lobes.

5. The apparatus of claim 1 further comprising a support structure coupled to the driving mechanism, the support structure configured to provide mechanical support to the driving mechanism.

6. The apparatus of claim 5 further comprising a hopper coupled to the support structure, the hopper configured to receive the grains to be crushed by the intermeshing mechanism.

7. The apparatus of claim 5 further comprising a grain collector assembly coupled to the support structure, the grain collector assembly configured to receive substantially uniform-sized particles formed by crushing the grains.

8. A method for crushing grains by an apparatus, the method comprising:
receiving the grains into an intermeshing mechanism of the apparatus, the intermeshing mechanism formed by a protruding member of a plurality of protruding members extending from a curved surface of a first roller of a plurality of rollers of the apparatus and two adjacent protruding members of a plurality of protruding members extending from a curved surface of a second roller of the plurality of rollers; and
rotating the first roller and the second roller by a driving mechanism for enabling the intermeshing mechanism to exert a crushing force on the grains,
wherein the first roller and the second roller are separated by a predefined clearance distance, and,
wherein the crushing force exerted on the grains by the intermeshing mechanism based on the rotation of the first roller and the second roller, crushes the grains.

9. The method of claim 8, wherein the plurality of protruding members of the first roller is composed of one of a plurality of teeth, a plurality of pins and a plurality of lobes.

10. The method of claim 8, wherein the plurality of protruding members of the second roller is composed of one of a plurality of teeth, a plurality of pins and a plurality of lobes.
